(19) United States
(12) Patent Application Publication
(10) Pub. No.: US 2007/0242351 A1
(43) Pub. Date: Oct. 18, 2007

(54) SCREEN, REAR PROJECTOR, AND IMAGE DISPLAY APPARATUS

(75) Inventors: Hideya SEKI, Okaya-shi (JP); Satoshi KINOSHITA, Matsumoto-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/734,596

(22) Filed: Apr. 12, 2007

(30) Foreign Application Priority Data
Apr. 17, 2006 (JP) 2006-113453

(51) Int. Cl. G03B 21/56

(52) U.S. Cl. 359/460

(57) ABSTRACT

A screen is disclosed. The screen includes: a main screen body having a diffusion layer provided in a loop shape; a support member that is provided at an inner side of the loop shaped diffusion layer and supports the loop shaped diffusion layer to be stretched thereover; and a driving unit that moves the loop shaped diffusion layer in parallel to a surface of the main screen body.

### BACKGROUND

1. Technical Field

The present invention relates to a screen, a rear projector, and an image display apparatus.

2. Related Art

In recent years, a projector has come into wide use. In addition to a front projection type projector that is used mainly for presentation, there is recently growing the recognition of a rear projection type projector as a form of a large-sized screen. The biggest advantage of a projection type display apparatus is that the projection type display apparatus can provide a screen having the same size as direct view type displays, such as a liquid crystal television or a PDP, with a low cost as compared with the direct view type displays. However, as the direct view type displays are also becoming cheap, high resolution and performance are requested even to projection type display apparatuses.

A projector illuminates light emitted from a light source onto a light modulation elements such as a liquid crystal light valve and projects projected light modulated by the light modulation element onto a screen, such that an image is displayed on the screen. At this time, while an image is being displayed on the screen, there occurs a peculiar phenomenon called scintillation in which the entire surface of the screen glares.

Here, a principle of occurrence of the scintillation will be described with reference to FIGS. 10A and 10B.

As shown in FIGS. 10A and 10B, light beams emitted from a light source 70 are transmitted through a liquid crystal, light valve and is then projected onto a screen 74 containing light diffusing agents 72. The projected light beams projected onto the screen 74 are diffused by the light diffusing agents 72 contained in the screen 74. The diffused light beams are diffracted due to the light diffusing agents 72 while passing through the screen. As a result, the diffused light beams move like two-dimensional waves. As shown in FIG. 10B, two spherical waves of the two-dimensional waves strengthen or weaken each other depending on the phase relationship between the two waves. As a result, the spherical waves appear as interference fringes between a surface of a screen and a viewer. When eyes of the viewer focus on an image surface S on which the interference fringes occur, the viewer recognizes the interference fringes as scintillation that causes the screen surface to glare.

The scintillation gives a viewer, who desires to see an image formed on the screen surface, an unpleasant feeling as if a veil, a lace cloth, or a cobweb exists between the screen surface and the viewer. In addition, since the viewer sees double images including an image on the screen surface and the scintillation, the eyes of the viewer desire to focus on both the images, which causes the viewer to feel fatigued.

Further, in recent years, the development of a new light source that will substitute for a high-pressure mercury lamp serving as a light source of a projector has been requested. In particular, the expectation on a laser light source as a next-generation light source for a projector is increasing in terms of energy efficiency, color reproduction, long life, instantaneous lighting, and the like. However, in the case when a laser light source that generates highly coherent light beams is used as a light source of a projector Instead of the high-pressure mercury lamp, the contrast of an interference fringes increase even more. As a result, the view cannot stand unpleasant feeling and fatigue due to the scintillation.

For this reason, techniques for reducing the scintillation have been proposed.

For example, JP-A-11-38512 discloses a screen having an emission-side light diffusion layer, an intermediate layer, and an incident-side light diffusion layer. The emission-side light diffusion layer is formed of a plastic material mixed with light diffusing agents, the intermediate layer is formed of a transparent plastic material, and the incident-side light diffusion layer is formed of a plastic material mixed with light diffusing agents. In this case, since the scintillation occurring in the incident-side light diffusion layer is diffused again in the emission-side light diffusion layer, the occurrence of the scintillation is reduced.

Furthermore, JP-A-2001-100316 and JP-A-2001-100317 disclose a screen for image projection that changes the relative position relationship between light diffusion layers by causing at least one of the light diffusion layers, which form the screen for image projection, to vibrate internally. Thus, the occurrence of scintillation is reduced by causing the light diffusion layer to vibrate internally.

However, there are following problems in the above techniques for reducing scintillation disclosed in JP-A-11-38512, JP-A-2001-100316, and JP-A-2001-100317.

(1) In JP-A-11-38512, since the emission-side light diffusion layer is fixed, the phase distribution of a space between a viewer and a screen, on which interference between light beams generated at points on a diffusion surface occurs, is also fixed. Accordingly, interference fringes are also recognized as a fixed image. For this reason, there has been a problem in that the scintillation cannot be basically reduced.

(2) In JP-A-2001-100316 and JP-A-2001-100317, since various kinds of vibrating methods using light beams, electric field, magnetic field, heat, stress, and the like are used, extra driving energy is needed. Furthermore, in the case of using the driving units, the efficiency of transmission of energy to the light diffusion layers is low and vibration, noise, unnecessary electromagnetic waves, and exhaust heat occur. These are causes of disturbing a viewer who wants a pleasant watching environment. In addition in the case of vibrating the light diffusion layers in the z direction (focusing direction), the height of an image is changed. As a result, the position of an outline of the image in the x-y direction is also changed, which has caused a problem in that the image is defocused.

### SUMMARY

An advantage of some aspects of the invention is that it provides a screen, a rear projector, and an image display apparatus capable of reducing occurrence of scintillation.

In order to solve the above problems, according to an aspect of the invention, a screen includes: a main screen body having a diffusion layer provided in a loop shape; a support member that is provided at an inner side of the loop shaped diffusion layer and supports the loop shaped diffusion layer to be stretched thereover; and a driving unit that moves the loop shaped diffusion layer in parallel to a surface of the main screen body.

In the screen described above, preferably, the main screen body has a plurality of diffusion layers including the loop shaped diffusion layer, at least one of the plurality of diffusion layers is disposed to be fixed to the main screen body, and the loop shaped diffusion layer is movable in parallel to a surface of at least one of the diffusion layers disposed to be fixed to the main screen body.

Further, in the screen described above, preferably, the diffusion layer disposed to be fixed to the main screen body is disposed at the inner side of the diffusion layer provided in the loop shape.

According to the configuration described above, since the loop shaped diffusion layer moves in parallel to the surface of the main screen body by means of the driving unit, a diffusion state of light beams passing through the diffusion layer of the main screen body changes. Accordingly, a pattern of interference fringes generated by diffusion and diffraction of the diffusion layer of the main screen body changes. As a result, the coherency between the light beams is reduced, which makes it possible to reduce the scintillation.

In addition, in the screen described above, preferably, the supporting member is a pair of rotatable rollers, and the diffusion layer moves in parallel to the surface of the main screen body when the pair of rollers are rotated by the driving unit.

According to the configuration described above, since the loop shaped diffusion layer is supported to be stretched over the pair of rollers, the diffusion layer circulates (rotates) due to the rollers when the rollers rotate. Thus, as viewed from the viewer side, the diffusion layer has a two-layered structure. In this case, since the two layers of the loop shaped diffusion layer relatively move in the directions opposite to each other, the scattering state of light beams passing through the screen changes with time. Accordingly, a pattern of interference fringes generated by diffusion and diffraction of the diffusion layer of the main screen body changes. As a result, as compared with a case in which a diffusion layer has a single layer, integration and averaging are realized due to an afterimage effect of eyes of a viewer, which makes it possible to effectively reduce the scintillation.

In addition, since the diffusion layer circulates, a point of discontinuity does not exist as compared with a case in which the diffusion layer reciprocates. Accordingly, it becomes possible to continuously eliminate the scintillation.

Moreover, since the loop shaped diffusion layer is moved by the pair of rollers, it is possible to reduce occurrence of sound or vibration, as compared with a case of vibrating a diffusion layer of a main screen body so as to reduce the scintillation.

In addition, since a special device is riot required unlike a fluid screen, the cost can be saved as compared with the fluid screen.

Further, according to another aspect of the invention, a screen includes: a main screen body having a diffusion layer; a pair of first and second rollers that support the diffusion layer to be stretched thereover; and a driving unit that moves the diffusion layer in parallel to a surface of the main screen body. The first roller causes the diffusion layer, which is wound around the first roller in a circumferential direction thereof, to be carried in parallel to the surface of the main screen body and the second roller causes the diffusion layer, which is carried by the first roller, to be wound around the second roller in a circumferential direction thereof.

In the screen described above, preferably, the main screen body has a plurality of diffusion layers, at least one of the plurality of diffusion layers is disposed to be fixed to the main screen body, and the diffusion layer that is not fixed to the main screen body is movable in parallel to a surface of at least one of the diffusion layers disposed to be fixed to the main screen body.

According to the configuration described above, since the diffusion layer moves in parallel to the surface of the diffusion layer disposed to be fixed to the main screen body, the diffusion state of light beams passing through the diffusion layer of the main screen body changes. As a result, a pattern of interference fringes generated by diffusion and diffraction of the diffusion layer of the main screen body changes and the coherency between the light beams is reduced, which makes it possible to reduce the scintillation.

In addition, according to the configuration described above, the screen is a winding type screen. Accordingly, by exchanging functions of the first and second rollers with each other, it is possible to move the diffusion layer wound around the second roller again in parallel to the surface of the diffusion layer. As a result, since the diffusion layer can move continuously, the scintillation can be effectively reduced.

According to still another aspect of the invention, a rear projector includes: a light source that emits light beams; a light modulation element that modulates the light beams emitted from the light source; and the above-described screen onto which the light beams modulated by the light modulation element are projected.

In the aspect of the invention, since the screen described above is included, it is possible to provide the rear projector capable of reducing the scintillation.

Further, according to still another aspect of the invention, an image display apparatus includes: a light source that emits light beams; the above-described screen; and a scanning unit that scans the light beams emitted from the light source onto the screen.

In the aspects of the invention, since the screen described above is included, it is possible to provide the image display apparatus capable of reducing the scintillation.

### BRIEF DESCRIPTION OF THE DRAWINGS

The invention will be described with reference to the accompanying drawings wherein like numbers reference like elements.

FIG. 1A is a view schematically illustrating the configuration of a rear projector according to an embodiment of the invention.

FIG. 1B is a view schematically illustrating the configuration of the rear projector according to the embodiment of the invention.

FIG. 2 is a view schematically illustrating the configuration of a projection optical system of the rear projector according to the embodiment of the invention.

FIG. 3A is a view schematically illustrating a screen according to a first embodiment of the invention.

FIG. 3B is a view schematically illustrating the screen according to the first embodiment of the; invention.

FIG. 4A is a view schematically illustrating a screen according to a second embodiment of the invention.

FIG. 4B is a view schematically illustrating the screen according to the second embodiment of the invention.

FIG. 5 is a view schematically illustrating a screen according to a third embodiment of the invention.

FIG. 6 is a view schematically illustrating a screen according to a fourth embodiment of the invention.

FIG. 7 is a view schematically illustrating a screen according to a fifth embodiment of the invention.

FIG. 8 is a view schematically illustrating a main screen body having a plurality of diffusion layers.

FIG. 9A is a view schematically illustrating the configuration of a modification of the rear projector according to the present embodiment.

FIG. 9B is a view schematically illustrating the configuration of a modification of the rear projector according to the present embodiment.

FIG. 10A is a view explaining a principle of occurrence of scintillation.

FIG. 10B is a view explaining the principle of occurrence of scintillation.

### DESCRIPTION OF EXEMPLARY EMBODIMENTS

Hereinafter, embodiments of the invention will be described with reference to the accompanying drawings. Moreover, in the drawings used in the following description, the scale of each member is appropriately adjusted so as to be recognizable.

### First Embodiment

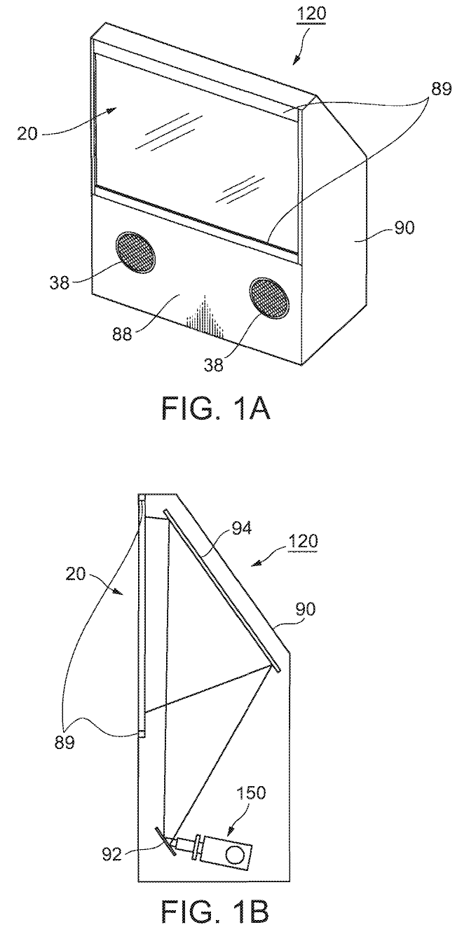

FIG. 1A is a perspective view schematically illustrating the configuration of a rear projector 120 according to a first embodiment of the invention, and FIG. 1B is a side sectional view illustrating the rear projector 120 shown in FIG. 1A. The rear projector 120 according to the present embodiment modulates light emitted from a light source by using a light modulation unit and then projects the modulated light onto a screen in an enlarged manner. Further, in the present embodiment, it is assumed that a front side of a screen 20 is a viewer-side surface 10c through which the viewer recognizes an image and a side opposite to the front side is a rear surface 10d. In addition, in the following description, an xyz orthogonal coordinate system is set. Referring to the xyz orthogonal coordinate system, the positional relationship among members will be described. In addition, it is assumed that a predetermined direction within a horizontal plane is an x direction, a direction orthogonal to the x direction within the horizontal plane is a y direction, and a direction orthogonal to the x and y directions is a z direction.

As shown in FIG. 1A, the rear projector 120 includes the screen 20, onto which an image is projected, and a casing 90 mounted on a rear-surface side of the screen 20. In addition, a front panel 88 is provided in the casing 90 below the screen, and openings 38 used to output sounds from speakers are provided at left and right sides of the front panel 88.

Next, the internal structure of the casing 90 of the rear projector 120 will be described.

As shown in FIG. 1B, a projection optical system 150 is disposed at a lower Dart of the casing 90 of the rear projector 120. Reflective mirrors 92 and 94 are disposed between the projection optical system 150 and the screen 20. Light beams emitted from the projection optical system 150 are reflected by the reflective mirrors 92 and 94 and are then projected onto the screen 20 in an enlarged manner.

Next, the schematic configuration of the projection optical system 150 of the rear projector 120 will be described.

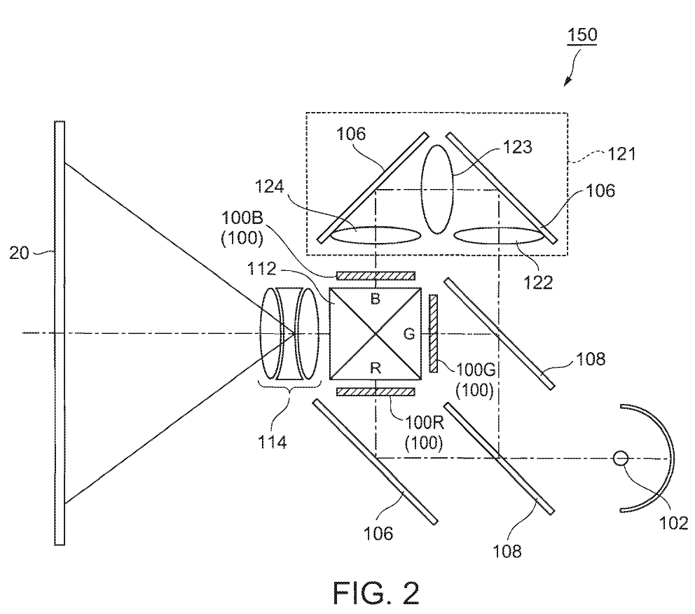

FIG. 2 is a view schematically illustrating the configuration of the projection optical system 150 of the rear projector 120. In FIG. 2, the casing 90 that forms the rear projector 120 is omitted for simplicity of the figure.

The projection optical system 150 includes a light source 102, light modulation elements 100 that modulate light beams emitted from the light source 102, and a projection lens 121 that projects the light beams modulated by the light modulation element 100. In the present embodiment, liquid crystal light valves 100R, 100G, and 130B are used as the light modulation elements 100.

As shown in FIG. 2, the projection optical system 150 includes a lamp unit 102 having a white light source, such as a halogen lamp. The light emitted from the lamp unit (light source) 102 is separated into light beams corresponding to three primary colors of R (red), G (green), and B (blue) by three mirrors 106 and two dichroic mirrors 108 provided inside the projection optical system 150. Then, the separated light seams are guided to the liquid crystal light valves 100R (red), 100G (green); and 100B (blue) corresponding to the respective primary colors of R, G, and B. Here, the liquid crystal light valves 100R, 100G, and 100B are driven by signals that correspond to primary colors of R, G, and B and are supplied from an image signal processing circuit (not shown).

In addition, in the case of a light beam corresponding to a B (blue) color, an optical path is long as compared with a case of a light beam corresponding to R (red) or G (green). Accordingly, in order to prevent the loss, the light beam corresponding to the B (blue) color is guided through a relay lens system 121 having an incidence lens 122, a relay lens 123, and an emission lens 124.

Light beams modulated by the liquid crystal light valves 100R, 100G, and 100B are incident on a dichroic prism 112 from three directions (liquid crystal light valves 100R, 100G, and 100B), respectively. The dichroic prism 112 causes light beams corresponding to R and B colors to be refracted by 90° and a light beam corresponding to a G color to go straight, such that light beams from light emission parts of the liquid crystal light valves 100R, 100G, and 100B are mixed. Then, the mixed light obtained by mixing the light beams from the light emission parts is projected onto the screen 20 through a projection lens 114.

Next, the schematic configuration of the screen 20 of the rear projector 120 will be described.

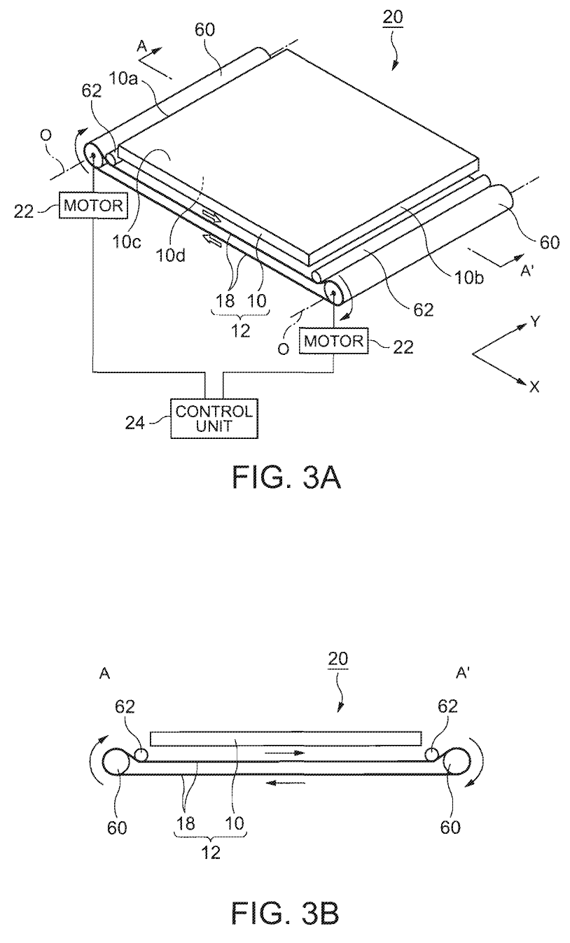

FIG. 3A is a perspective view schematically illustrating the configuration of a screen according to the present embodiment, and FIG. 3B is a cross-sectional view taken along the line IIIB-IIIB of the screen shown in FIG. 3A.

As shower in FIGS. 3A and 3B, the screen 20 includes a main screen body 12 and rollers 60 serving to move the main screen body 12 in a predetermined direction.

The main screen body 12 includes a diffusion plate 10 (diffusion layer) and a diffusion sheet 18 (diffusion layer) having rectangular shapes in plan view. The diffusion plate 10 diffuses light beams illuminated onto the main screen body 12 to enlarge a viewing range of a viewer and is fixed and mounted on a frame 89 of the casing 90 shown in FIGS. 1A and 1B. In addition, diffusing agents are uniformly distributed within the diffusion plate 10. As the diffusing agents, preferably, copolymer, such as silicon oxide, alumina, calcium carbonate, glass beads, and acrylic resin based materials, or amorphous organic materials such as silicon resin based materials. The viewer-side surface 10c of the diffusion plate 10 is attached with a hard coat layer (not shown) serving to protect the main screen body 12 including the diffusion plate 10.

In addition, slender and long rollers 60 having cylindrical shapes are disposed on rear surface sides of left and right sides 10a and 10b of the diffusion plate 10. The rollers 60 are disposed in a non-display region, in which the rollers 60 and the main screen body 12 do not overlap each other in plan view, so as to be spaced apart from the main screen body 12. The rollers 60 are detachably mounted within the casing 90 of the rear projector 120 shown in FIGS. 1A and 1B. In addition, the rollers 60 is connected with a motor 22 (driving unit), such that the rollers 60 can be rotated by a driving signal supplied from a control unit 24. Moreover, the rollers 60 may be integrally formed together with a frame 89 that supports the main screen body 12. In addition, the motor 22 may be provided inside the roller 60.

Furthermore, rotary shafts O of the rollers 60 are disposed to be parallel to the left and right sides 10a and 10b of the diffusion plate 10, and the rollers 60 can rotate around the rotary shafts O. In the present embodiment, in order to move the diffusion sheet 18 in the longitudinal direction (x direction) of the diffusion plate 10, the rollers 60 are controlled to rotate rightward with respect to the rotary shafts O. In addition, tension rollers 62 are disposed between the roller 60, which is located at the left side of FIG. 3A, and the left side 10a of the diffusion plate 10 and the roller 60 located at the right side of FIG. 3A, and the right side 10b of the diffusion plate 10, respectively. The tension rollers 62 can move in the vertical direction with respect to a surface of the diffusion sheet 18. In addition, the tension of the diffusion sheet 18 can be controlled by adjusting the position of the tension roller 62.

On a rear surface side of the diffusion plate 10, the loop-shaped diffusion sheet 18 is disposed to overlap the diffusion plate 10 in plan view. The diffusion sheet 18 and the diffusion plate 10 are disposed with a predetermined gap therebetween in order to prevent friction between the diffusion sheet 18 and the diffusion plate 10 when the diffusion sheet 18 moves. The rollers 60 are disposed on inner circumferential sides of the diffusion sheet 18, and the diffusion sheet 18 is supported by the rollers 60 so as to be stretched between the rollers 60 in the loop shape. Thus, since the diffusion sheet 18 rotates by the rollers 60, the diffusion sheet 18 has a two-layered structure as viewed from a viewer side. Further, in the present embodiment, there is used the diffusion sheet 18 in which the same diffusing agents as those diffused within the diffusion plate 10 are diffused and which is more flexible than the diffusion plate 10 and has a lower diffusion property than the diffusion plate 10

The rollers 60 (motor 22) are connected to the control unit 24 provided inside the casing 90. The control unit 24 supplies driving signals to the rollers 60 at the same time as the rear projector 120 is powered on to project an image onto the screen 20. At this time, the driving signals are supplied to the rollers 60 in synchronization therewith. As a result, the diffusion sheet 18 circulates (reciprocates) between the rollers 60 in parallel to the longitudinal side of the diffusion plate 10 (in the x direction).

On the other hand, the control unit 24 stops supplying the driving signal to the rollers 60 when the rear projector 120 is powered off so that an image is not projected onto the screen 20. As a result, the diffusion sheet 18 stops.

In the present embodiment, the loop shaped diffusion sheet 18 is supported by the rollers 60 while the diffusion sheet 18 is stretched over the rollers 60. Accordingly, when the rollers 60 rotate, the diffusion sheet 18 also moves due to the rollers 60 to circulate (rotate). For this reason, as viewed from a viewer side, the diffusion sheet 18 has the two-layered structure. In this case, since the two layers of the loop shaped diffusion sheet 18 relatively move in the directions opposite to each other, the scattering state of light beams passing through the screen 20 changes with time. Accordingly, a pattern of interference fringes generated by diffusion and diffraction of the diffusion sheet 18 and the diffusion plate 10 of the main screen body 12 changes. As a result, as compared with a case in which a diffusion plate has a single layer, integration and averaging are realized due to an afterimage effect of eyes of a viewer, which makes it possible to effectively reduce the scintillation.

Further, since the diffusion sheet 18 circulates, a point of discontinuity does not exist as compared with a case in which the diffusion sheet 18 reciprocates. Accordingly, it becomes possible to continuously eliminate the scintillation.

Furthermore, since the diffusion sheet 18 moves in the loop shape by means of the rollers 60, it is possible to reduce occurrence of sound or vibration, as compared with a case of vibrating a diffusion plate of the main screen body 12 so as to reduce the scintillation.

In addition, since a special device is not required unlike a fluid screen, the cost can be saved as compared with the fluid screen.

### Second Embodiment

Next, a second embodiment of the invention will be described with reference to the accompanying drawings.

In the present embodiment, the position at which a diffusion sheet is disposed is different from that in the first embodiment. In addition, the other configuration of a rear projector in the present embodiment is the same as that in the first embodiment. Accordingly, the same constituent components as in the first embodiment are denoted by the same reference numerals, and detailed explanation thereof will be omitted.

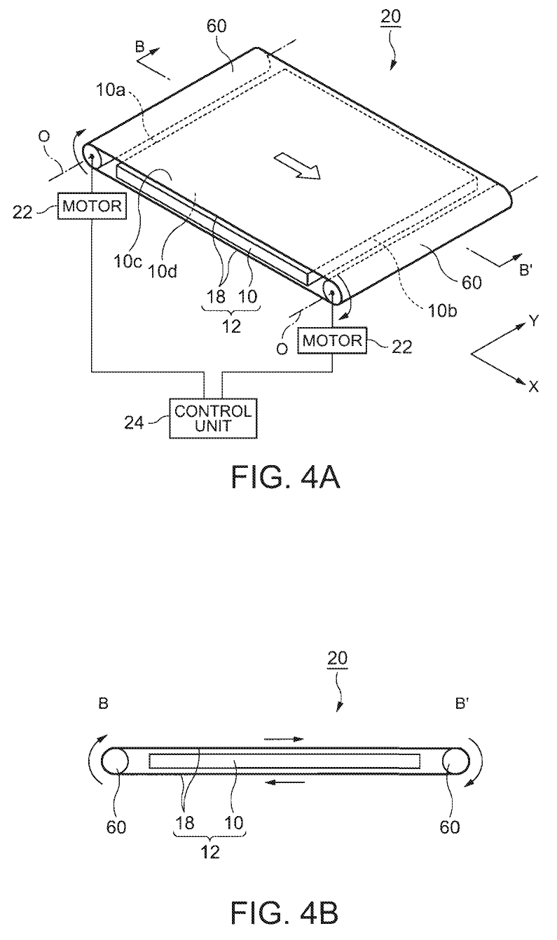

FIG. 4A is a perspective view schematically illustrating the configuration of a screen 20 according to the present embodiment, and FIG. 3B is a cross-sectional view taken along the line IIIB-IIIB of the screen shown in FIG. 3A.

As shown in FIGS. 4A and 4B, rollers 60 are disposed beside left and right sides 10a and 10b of a diffusion plate 10. The rollers 60 are disposed in a non-display region, in which the rollers 60 and the main screen body 12 do not overlap each other in plan view, so as to be spaced apart from the main screen body 12. The rollers 60 are detachably mounted within the casing 90 of the projector shown in FIGS. 1A and 1B. In addition, the rollers 60 is connected with a motor 22 (driving unit), such that the rollers 60 can be rotated by a driving signal supplied from a control unit 24.

A diffusion sheet 18 is stretched between the rollers 60 in the loop shape. Thus, since the diffusion sheet 18 rotates by the rollers 60, the diffusion sheet 18 has a two-layered structure as viewed from a viewer side. In this case, the diffusion plate 10 is disposed between the two layers of the loop shaped diffusion sheet 18. A viewer-side surface 10c and a rear surface 10d of the diffusion plate 10 are covered with the diffusion sheet 18. In addition, the diffusion plate 10 is disposed to be spaced apart from the diffusion sheet 18.

The rollers 60 (motor 22) are connected to the control unit 24 provided inside the casing 90. The control unit 24 supplies driving signals to the rollers 60 at the same time as the rear projector 120 is powered on to project an image onto the screen 20. At this time, the driving signals are supplied to the rollers 60 in synchronization therewith. As a result, as viewed from the viewer-side surface 10c of the diffusion plate 10, the diffusion sheet 18 moves in parallel from a left side of the diffusion plate 10 in the longitudinal direction thereof to a right side (+x direction) In addition, as viewed from the rear surface 10d of the diffusion plate 10, the diffusion sheet 18 moves In parallel from the right side of the diffusion plate 10 in the longitudinal direction thereof to the left side (−x direction).

On the other hand, the control unit 24 stops supplying the driving signal to the rollers 60 when the rear projector 109 is powered off so that an image is not projected onto the screen 20.

According to the present embodiment, the diffusion sheet 18 has a two-layered structure because the diffusion sheet 18 is rotated by the rollers 60, in the same manner as the first embodiment. That is, the loop shaped diffusion sheet 18 has a structure in which the two layers thereof relatively move in the directions opposite to each other. As a result, as compared with a case in which a diffusion plate has a single layer, integration and averaging are realized due to the afterimage effect of eyes of a viewer, which makes possible to effectively reduce the scintillation.

### Third Embodiment

Next, a third embodiment of the invention will be described with reference to the accompanying drawings.

Although the diffusion sheet moves in the one direction (x direction) in the embodiments described above, the present embodiment is different from the embodiments described above in that the diffusion sheet moves in two directions (x-y directions) In addition, the other configuration of a rear projector in the present embodiment is the same as that in the first embodiment. Accordingly, the same constituent components as in the first embodiment are denoted by the same reference numerals, and detailed explanation thereof will be omitted.

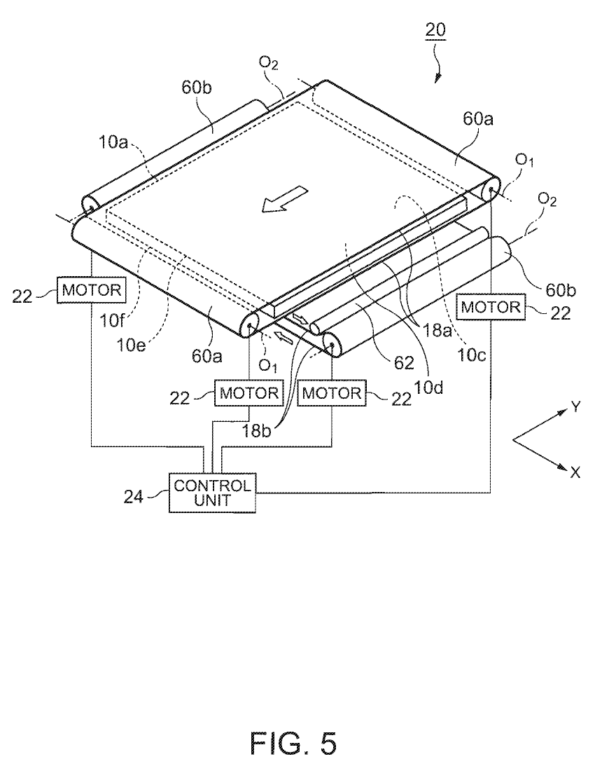

FIG. 5 is a perspective view schematically illustrating the configuration of a screen 20 according to the present embodiment.

As shown in FIG. 5, rollers 60a are disposed beside upper and lower sides 10e and 10f of the diffusion plate 10. In addition, a diffusion sheet 18a is stretched between the rollers 60a in the loop shape. The diffusion plate 10 is disposed between the diffusion sheets 18a that are stretched in the loop shape. Furthermore, rotary shafts O1 of the rollers 60a are disposed to be parallel to the upper and lower sides 10e and 10f of the diffusion plate 10, and the rollers 60a can rotate around the rotary shafts O1. In the present embodiment, in order to move the diffusion sheet 18a in parallel in the short-side direct on (y direction) of the diffusion plate 10, the rollers 60a are controlled to rotate rightward with respect to the rotary shafts O1.

Furthermore, rollers 60b are disposed on rear surface sides of left and right sides 10a and 10b of the diffusion plate 10. In addition, a diffusion sheet 18b is stretched between the rollers 60b in the loop shape. Furthermore, rotary shafts O2 of the rollers 60b are disposed to be parallel to the left and right sides 10a and 10b of the diffusion plate 10, and the rollers 60b can rotate around the rotary shafts O2. In the present embodiment, in order to move the diffusion sheet 18b in the short-side direction (x direction) of the diffusion plate 10; the rollers 60b are controlled to rotate rightward with respect to the rotary shafts O2.

The rollers 60a and 60b are connected to the control unit 24 provided inside the casing 90. The control unit 24 supplies driving signals to the rollers 60a and 60b at the same time as the rear projector 120 is powered on to project an image onto the screen 20. At this time, the driving signals are supplied to the rollers 60a and 60b in synchronization therewith.

As a result, the diffusion sheet 18a circulates between the rollers 60a in the longitudinal direction (y direction) of the diffusion plate 10, and the diffusion sheet 18b circulates between the rollers 60b in the short-side direction (x direction) of the diffusion plate 10b.

On the other hand, the control unit 24 stops supplying the driving signal to the rollers 60a and 60b when the rear projector 120 is powered off so that an image is riot projected onto the screen 20. In addition, the rollers 60a and 60b may be driven alternately.

According to the present embodiment, the diffusion sheet 18a moves in the y direction and at the same time, the diffusion sheet 18b moves in the x direction. That is, the diffusion sheets 18a and 18b moves relatively with respect to surfaces of the diffusion plate 10. Accordingly, the scattering state of light beams passing through the screen 20 changes with time, which changes a pattern of interference fringes generated by diffusion and diffraction of the diffusion sheets 18a and 18b and the diffusion plate 10 of the main screen body 12. As a result, as compared with a case in which a diffusion plate has a single layer, integration and averaging are realized due to the afterimage effect of eyes of a viewer, which makes it possible to effectively reduce the scintillation.

Moreover, in the present embodiment, the configuration of the screen 20 in which the first embodiment and the second embodiment are used in combination has been described. However, the invention is not limited thereto. For example, it is possible to move a plurality of diffusion plates 10 in the plural directions by stacking the plurality of diffusion plates 10 using a plurality of rollers.

### Fourth Embodiment

Next, a fourth embodiment of the invention will be described with reference to the accompanying drawings.

Although the diffusion sheets circulate in the loop shape in the embodiments described above, the present embodiment is different from the embodiments described above in that a diffusion sheet is wound and does not reciprocate. In addition, the other configuration of a rear projector in the present embodiment is the same as that in the first embodiment. Accordingly, the same constituent components as in the first embodiment are denoted by the same reference numerals, and detailed explanation thereof will be omitted.

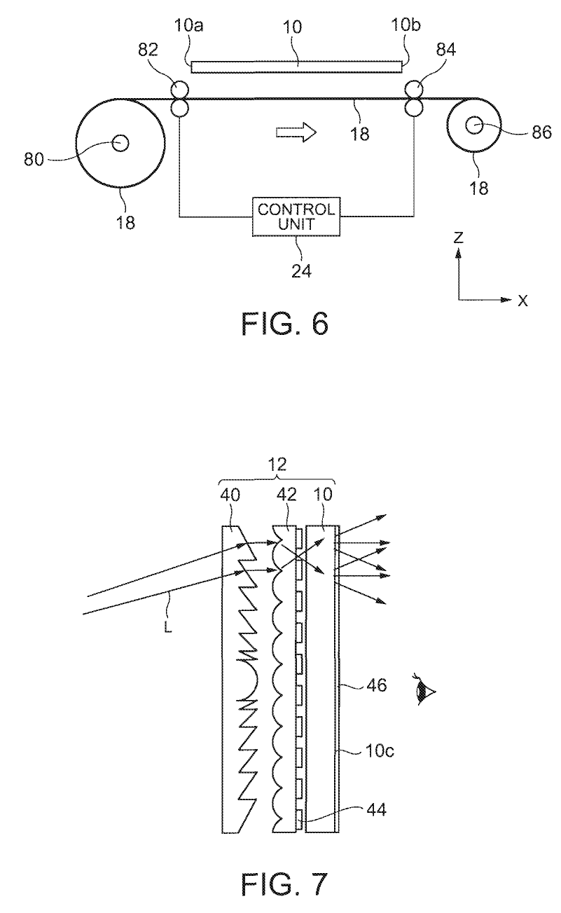

FIG. 6 is a cross-sectional view schematically illustrating the configuration of a screen according to the present embodiment.

As shown in FIG. 6, a receiving roller 80 (first roller) on which a diffusion sheet 18 is wound in the circumferential direction thereof is disposed on a rear-surface side adjacent to a left side 10a of a diffusion plate 10, and a carrying roller 82 (first roller) serving to carry the diffusion sheet 18 is disposed on a side of the receiving roller 80 in the movement direction (+x direction) of the diffusion sheet 18 of the receiving roller 80. The receiving roller 80 may also have a function of the carrying roller 82.

On the other hand, a discharge roller 84 (second roller) that causes the diffusion sheet 18 carried by the carrying roller 82 to be carried to a winding roller is disposed on a rear-surface side adjacent to a right side 10b of the diffusion plate 10, and a winding roller 86 (second roller) on which the carried diffusion sheet 18 is wound in the circumferential direction thereof is disposed in the carrying direction (+x direction) of the discharge roller 84. The winding roller 86 may also have a function of the discharge roller 84.

In addition, a motor 22 (driving unit) is connected to the receiving roller 80, the carrying roller 82, the discharge roller 84, and the winding roller 86, such that the receiving roller 80, the carrying roller 82, the discharge roller 84, and the winding roller 86 can be rotated by a driving signal supplied from a control unit 24. As a result, the diffusion sheet 18 moves in parallel to the x direction of a surface of the diffusion plate 10.

According to the present embodiment, since the diffusion sheet 18 moves in parallel to the x direction of the surface of the diffusion plate 10, the diffusion state of light beams passing through the diffusion plate 10 changes. As a result, a pattern of interference fringes generated by diffusion and diffraction of the diffusion plate 10 changes and the coherency between the light beams is reduced, which makes it possible to reduce the scintillation.

In addition, by exchanging functions of the receiving roller 80 and the winding roller 86 with each other and exchanging functions of the carrying roller 82 and the discharge roller 84 with each other, it is possible to cause the diffusion sheet 18 wound around the winding roller 86 to repeatedly move in parallel to the surface of the diffusion plate 10. Thus, since the diffusion sheet 18 can move continuously, it is possible to effectively reduce the scintillation.

### Fifth Embodiment

Next, a fifth embodiment of the invention will be described with reference to the accompanying drawings.

In the embodiments described above, the main screen body is formed by a single-layered diffusion plate. In contrast, the present embodiment is different from the embodiments described above in that a plurality of layers as well as a diffusion plate forms a layer having a diffusing function. In addition, the other configuration of a rear projector in the present embodiment is the same as that in the first embodiment. Accordingly, the same constituent components as in the first embodiment are denoted by the same reference numerals, and detailed explanation thereof will be omitted.

FIG. 7 is a perspective view schematically illustrating the configuration of a main screen body 12 according to the present embodiment.

As shown in FIG. 7, the main screen body 12 includes a diffusion plate 10, a lenticular lens 42 serving to condense an image, and a Fresnel lens 40 serving to convert light beams projected onto the screen 20 to parallel light beams. These layers are disposed on an optical axis L of projected light in the order of the diffusion plate 10, the lenticular lens 42, and the Fresnel lens 40 from the viewer side.

In addition, a hard coat layer 46 is attached on a viewer-side surface 10c of the diffusion plate 10. In addition, a black mask 44 is formed in matrix on a viewer-side surface 10c of the lenticular lens 42.

Even in the case according to the present embodiment in which the main screen body 12 is configured to include a plurality of layers, it is possible to effectively reduce the scintillation, in the same manner as the first embodiment.

### Sixth Embodiment

Next, a sixth embodiment of the invention will be described with reference to the accompanying drawings.

The present embodiment is different from the embodiments described above in that a scanning part other than the light modulation element is used in the configuration of a rear projector. In addition, the other configuration of a rear projector in the present embodiment is the same as that in the first embodiment. Accordingly, the same constituent components as in the first embodiment are denoted by the same reference numerals, and detailed explanation thereof will be omitted.

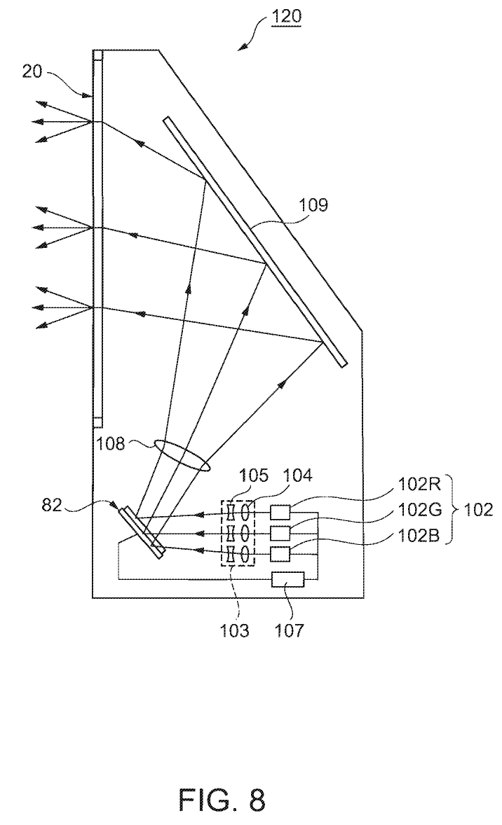

FIG. 8 is a cross-sectional view schematically illustrating the configuration of a rear projector 120.

As shown in FIG. 8, the rear projector 120 according to the present embodiment includes a light source 102 that emits laser beams, a lens optical system 103 having a collimate optical system 1041 and a beam shaping optical system 105, a scanner 82 that scans incident laser beams in the two-dimensional direction, a projection lens 108 that projects scanned light in an enlarged manner, and a reflective mirror 109 that reflects the projected light toward a screen 20. The light source 102 has a red laser diode 102R that emits a red-colored laser beam, a green laser diode 102G that emits a green-colored laser beam, and a blue laser diode 102B that emits a blue-colored laser beam.

Laser beams emitted from the laser diodes 102R, 102G, and 102B are incident on the scanner 82 through the lens optical system 103. The incident laser beams are scanned in the two-dimensional direction by the scanner 82 and are then projected onto the screen 20 through the projection lens 108 and the reflective mirror 109. Thus, the rear projector 120 according to the present embodiment creates an image by causing the scanner 82 to scan the laser beams emitted from the light source 102 onto the screen 20.

As described in the present embodiments even in the scan-type rear projector 120 using a laser light source, a diffusion sheet 18 of the screen 20 can be moved by rollers 60. Accordingly, since the same operations and effects described in the above embodiments can be obtained, it is possible to effectively reduce the scintillation.

In addition, a technical scope of the invention is not limited to those embodiments described above, but various modifications of the embodiments may be made without departing from the spirit or scope of the invention.

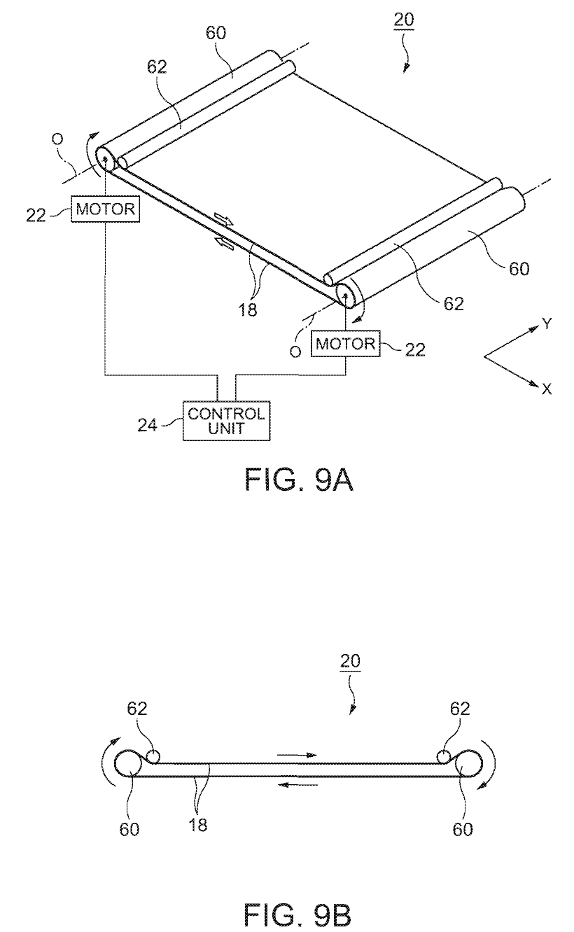

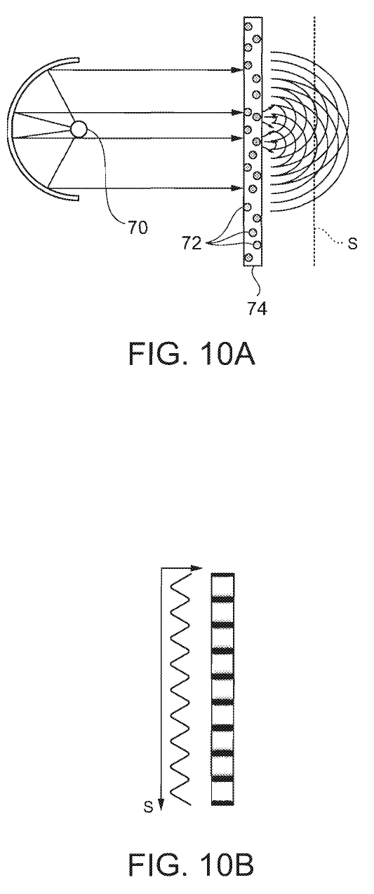

For example, in the embodiments described above, the main screen body 12 includes the diffusion plate 10 and the diffusion sheet 18 that moves in parallel to the surface of the diffusion plate 10. However, as shown in FIGS. 9A and 9B, in the case of using the diffusion sheet 18 whose diffusing function is the same as that of the diffusion plate 10, the main screen body 12 may include only the diffusion sheet 18 without the diffusion plate 10.

Further, in the embodiments described above, the pair of rollers 60 is used as a unit that moves the diffusion sheet 18. However, any kind of mechanism may be appropriately selected as long as it can move the diffusion sheet 18.

Furthermore, in the embodiment described above, examples of using a transmissive liquid crystal light value as a light modulation element are shovel. However, a reflective liquid crystal light value and a micro-mirror array device may be used as a light modulation element. In this case, the configuration of the projection optical system 150 is appropriately changed.

In addition, in the embodiments described above, the screen 20 having the configuration is applied to the rear projector 170. However, the screen 20 having the configuration may be applied to a screen of a front projection type projector.

In addition, the invention is not limited to a pair of supporting members, such as the rollers 60. For example, a plurality of pairs of supporting members may be provided such that a loop shaped diffusion layer is stretched over the supporting members.

The entire disclosure of Japanese Patent Application No. 2006-113453, filed Apr. 17, 2006 is expressly incorporated by reference herein.

What is claimed is:

1. A screen comprising:
a main screen body having a diffusion layer provided in a loop shape;
a support member that is provided at an inner side of the loop shaped diffusion layer and supports the loop shaped diffusion layer to be stretched thereover; and
a driving unit that moves the loop shaped diffusion layer in parallel to a surface of the main screen body.

2. The screen according to claim 1,
wherein the main screen body has a plurality of diffusion layers including the loop shaped diffusion layer,
at least one of the plurality of diffusion layers is disposed to be fixed to the main screen body, and
the loop shaped diffusion layer is movable in parallel to a surface of at least one of the diffusion layers disposed to be fixed to the main screen body.

3. The screen according to claim 1,
wherein the diffusion layer disposed to be fixed to the main screen body is disposed at the inner side of the diffusion layer provided in the loop shape.

4. The screen according claim 1,
wherein the supporting member is a pair of rotatable rollers, and
the diffusion layer moves in parallel to the surface of the main screen body when the pair of rollers are rotated by the driving unit.

5. A screen comprising:
a main screen body having a diffusion layer;
a pair of first and second rollers that support the diffusion layer to be stretched thereover; and
a driving unit that moves the diffusion layer in parallel to a surface of the main screen body,
wherein the first roller causes the diffusion layer, which is wound around the first roller in a circumferential direction thereof, to be carried in parallel to the surface of the main screen body and the second roller causes the diffusion layer, which is carried by the first roller, to be wound around the second roller in a circumferential direction thereof.

6. The screen according to claim 5,
wherein the main screen body has a plurality of diffusion layers,
at least one of the plurality of diffusion layers is disposed to be fixed to the main screen body, and
the diffusion layer that is not fixed to the main screen body is movable in parallel to a surface of the diffusion layers disposed to be fixed to the main screen body.

7. A rear projector comprising:
a light source that emits light beams;
a light modulation element that modulates the light beams emitted from the light source; and
the screen according to claim 1 onto which the light beams modulated by the light modulation element are projected.

8. An image display apparatus comprising:
a light source that emits light beams;
the screen according to claim 1; and
a scanning unit that scans the light beams emitted from the light source onto the screen.
